(19) United States
(12) Patent Application Publication
(10) Pub. No.: US 2007/0268236 A1
(43) Pub. Date: Nov. 22, 2007

(54) Methods and systems for LCD backlight color control

(76) Inventor: Neil Morrow, San Jose, CA (US)

Correspondence Address: WAGNER, MURABITO & HAO LLP, Third Floor, Two North Market Street, San Jose, CA, 95113, US

(21) Appl. No.: 11/436,210

(22) Filed: May 17, 2006

(51) Int. Cl. G09G 3/36

(52) U.S. Cl. 345/102

(57) ABSTRACT

The present invention provides a low-cost, highly flexible display system which comprises a programmable CPU, a LCD module for displaying visual information, an array of light emitters for providing backlighting to the LCD module, an array of light emitter driver circuits, and an array controller. The programmable CPU accesses ROM and RAM memory and comprises at least one input/output protocol for communicating with components on the display system. A single light driver circuit controls the intensity of a set of light emitters. The array controller connects to a number of light emitter driver circuits and acts as a central point of communication between the CPU and the array of light emitter driver circuits and color sensors.

### FIELD OF THE INVENTION

The present invention relates to the design and manufacturing of display systems, the devices on display systems, and the methods for managing Liquid Crystal Display (LCD) backlighting for display systems.

### BACKGROUND ART

One example color space is the International Commission on Illumination (CIE) system, that characterizes colors by a luminance parameter and two color coordinates which specify a point on the CIE chromaticity diagram. The CIE system is factored by sensitivity curves which have been measured for the human eye, and covers the scope of color perception called the gamut of human color vision.

Conventional approaches to providing a color gamut on computer monitor and entertainment display systems match colors in the CIE system by combining a given set of three primary colors (such as red, green, and blue), and provide a range of color represented on the CIE system by a triangular region joining the coordinates of the three colors. This triangular region is a subset of the CIE system, and these conventional systems, often called Red-Green-Blue (RGB) systems, cannot display the range of human color perception. Additionally, the RGB system is challenged by hue and saturation associated with a given color name that can vary over a considerable range, a range that is further complicated by several variations of different kinds of display monitor technologies, and a range of characteristics among manufacturers and models of monitors within a technology.

Conventional approaches to liquid crystal display (LCD) monitors use a white backlighting system, where white light is provided by a set of white light emitters. Care is generally taken to provide a consistent distribution of white light across the back of the LCD panel.

There are some advantages to using the RGB approach discussed above to provide a specific color of white to the backlight. One advantage is to refine the color RGB gamut with the backlight that may be more controllable than the liquid crystal elements. Another advantage of the RGB system is the ability to refine the backlight color over the life of the system, as light emitters may drift in the color space over time and temperature variations. Finally, the low cost of red, green, and blue light emitters may present a cost reduction opportunity. Therefore, demands have arisen for systems, devices, and methods to provide a low-cost, highly flexible approach to managing the LCD backlight color of RGB systems.

### SUMMARY OF THE INVENTION

According to one embodiment of the present invention there is provided a display system architecture for managing the color of an LCD backlight. The display system comprises a programmable Central Processing Unit (CPU) which comprises at least one input/output protocol for communicating with components on the display system, a LCD module for displaying visual information, an array of light emitters for providing backlighting to the LCD module, an array of light emitter driver circuits which control the intensity of light emitters, and an array controller which connects to a number of light emitter driver circuits.

According to another embodiment of the present invention there is provided a device called an array controller here, preferably an integrated circuit device, which acts as a central point of communication between a CPU and an array of light emitter driver circuits and color sensors. An input/output bus interface protocol is used for the array controller to communicate with other system devices. According to one embodiment, the input/output bus interface protocol (105) is a Philips I2C protocol. The array controller includes an analog to digital conversion (A2D) circuit if the output from the color sensors is an analog signal. The array controller connects to a plurality of light emitter driver circuits, often called inverter circuits, and preferably integrated circuits. These connections may also use the Philips I2C protocol, or a pulse-width-modulated (PWM) signal to control the intensity of connected light emitters.

The display system CPU operates algorithms to determine new light emitter intensities based on color feedback from the system. Color feedback and intensity control are achieved by utilizing the input/output communication protocol between the CPU and the array controller.

### BRIEF DESCRIPTION OF THE DRAWINGS

FIG. 1 illustrates a system diagram of a display system, in accordance with one embodiment of the present invention.

FIG. 2 illustrates a diagram of the LCD backlight sub-system in FIG. 1, in accordance with one embodiment of the present invention.

FIG. 3 illustrates a diagram of a high level emitter driver circuit, in accordance with one embodiment of the present invention.

FIG. 4 illustrates a block diagram of an array controller device, in accordance with one embodiment of the present invention.

FIG. 5 illustrates a block diagram of an array controller device with an integrated programmable CPU, in accordance with one embodiment of the present invention.

FIG. 6 illustrates a flow chart of a color management method for the LCD backlight sub-system in FIG. 2, in accordance with one embodiment of the present invention.

FIG. 7 illustrates a flow chart of a circuit selector method to calculate a second, updated, new desired color intensity data, in accordance with one embodiment of the present invention.

FIG. 8 illustrates the I2C protocol to communicate intensity information to the emitter driver circuits, in accordance with one embodiment of the present invention.

### DETAILED DESCRIPTION

Reference will now be made in detail to the preferred embodiments of the present invention, methods and systems for LCD backlight color control, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Accordingly, various embodiments of the present invention disclose a low-cost, highly flexible approach to managing the LCD backlight color of RGB systems. The present invention provides for advantages such as easy modification of color management algorithms operating on a display system. The algorithms can be quickly modified to meet design criteria and constraints, such as emitter matrix configuration, and easily tuned and calibrated to specific system requirements. The ease of modifying algorithms offers LCD display system manufacturers a way to differentiate their products based on unique backlight color management algorithms. Another advantage is the array controller offering a central point of communication between the CPU and light emitter driver circuits can offer cost advantages. For example, the light emitter driver circuits do not need to be individually addressed by an input/output communications protocol directly, removing the need for such protocol logics and address configuration terminals. Two or three address configuration terminals are used for devices based on Philips I2C protocol to select the slave address. Similarly, the protocol logics and interface terminals may be reduced by a central communications point to a set of color sensors.

Some portions of the detailed description which follow are presented in terms of procedures, operations, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed operation, logic block, process, etc., is here, and generally, conceived to be self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining,” “storing,” “establishing,” and “enabling,” or the like, refer to the actions and processes of a computer system, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

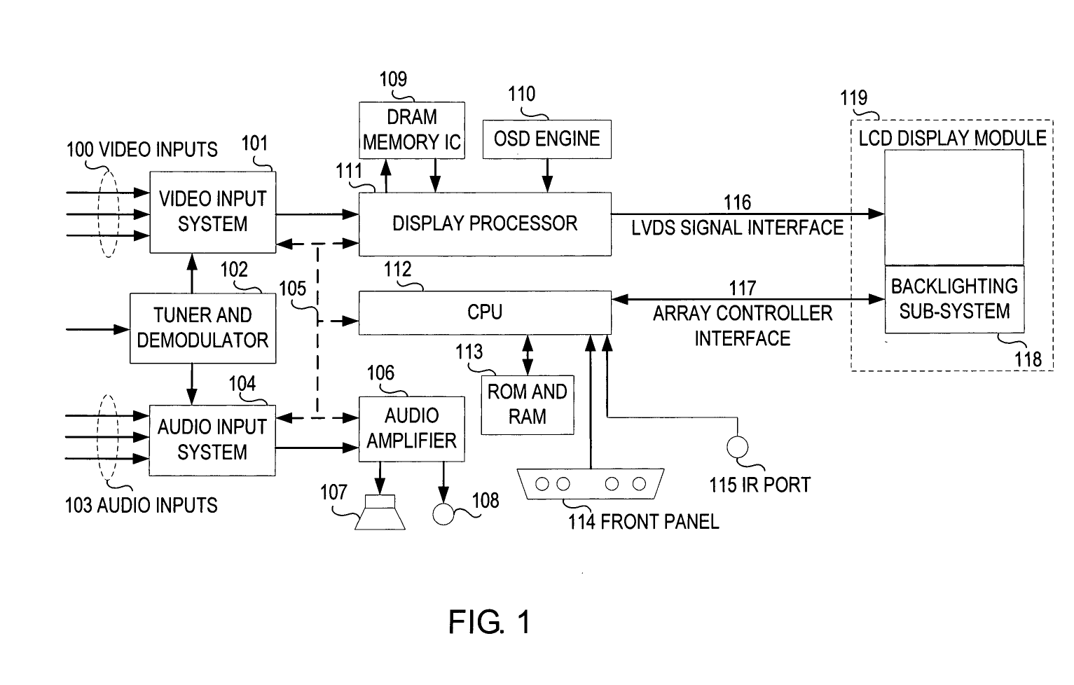

FIG. 1 illustrates a system diagram for the display system. The system includes a video input system (101) to accept a plurality of analog and digital video inputs (100) in accordance with one embodiment of the present invention. Video inputs (100) may include analog composite video, Composite Video Broadcast Signal (CVBS)-type supporting National Television Systems Committee (NTSC), Phase Alternating Line (PAL), and/or Sequential Electronic Color With Memory (SECAM) variety; whereas an analog-to-digital (A2D) conversion is performed and further video decoding, including but not limited to conventional 2D or three-dimensional (3D) comb filtering, is performed to generate a good digital representation of the analog video input.

Video inputs (100) may include any of several methods to deliver images to a display system, such as a Digital Visual Interface (DVI) method, DVI-HDCP (High-bandwidth Digital Content Protection), High Definition Multimedia Interface (HDMI), a traditional PC monitor analog RGB type, such as eXtended Video Graphics Array (xVGA), a component YCbCr analog variety interfaced through a D4 connector, a digital S-Video connection, and many other choices. Generally, the video input system (101) includes high-speed A2D conversion and logic to create a digital representation of the video input to deliver on a digital video signal interface to a display processor (111) for further processing and image rendering. Some state-of-the-art display processors (111) integrate the video input system (101).

Some display systems, as shown in FIG. 1, include a TV tuner and demodulator (102) system for receiving RF signals for terrestrial television reception, whereas state-of-the-art tuners and demodulator systems (102) support digital TV reception using standard protocols such as Digital Video Broadcasting Television (DVB-T), Advanced Television Systems Committee (ATSC), and Association of Radio Industry Business (ARIB). The TV tuner and demodulator system (102) generally provides video decoding, and may pass video data to the video input system (101), or can directly interface to a secondary auxiliary digital video signal interface to a display processor (111). Furthermore, the data channel for digital TV broadcast is decoded by either the tuner and demodulator system (102). In the case of receiving digital TV broadcasts based on the MPEG-2 compression algorithm, an MPEG-2 transport stream (TS) can be delivered to a highly-integrated display processor (111).

Although state-of-the-art display processors (111) integrate video decoding functions, they may not include the tuner and demodulator (102) elements. However, state-of-the-art tuners are manufactured in a semiconductor manufacturing process. It is conceived that a display processor (111) may integrate the TV and demodulator system (102), in one embodiment of the present invention.

For analog and digital TV reception, the tuner and demodulator system (102) outputs the audio information to the audio input system (104). The audio input system (104) accepts audio input from a variety of external audio sources (103), such as audio/video (AV) analog audio inputs, tuner inputs, and PC audio inputs. Generally, the audio input system outputs at least a left and right channel of stereo audio to an audio amplifier (106), which drives the sound systems such as a speaker system (107) or a headphone jack system (108).

Display systems implement a programmable CPU sub-system (112), which in state-of-the-art systems is generally either an 8-bit discrete processor, or 32-bit Reduced Instruction Set Computer (RISC) processor integrated to the display processor (111) in one embodiment of the present invention. The programmable CPU sub-system (112) interfaces to random Access Memory (RAM) and Read Only Memory (ROM) memory (113), which may be integrated into the CPU sub-system, and operates an instruction set to provide general system control algorithms, such as interfacing with a front input panel (114) for volume and channel control, receiving control through an infrared IR port (115), setting parameters of the display module, configuring system devices, etc. An input/output bus interface protocol (105) is used to communicate with other system devices. According to one embodiment, the input/output bus interface protocol (105) is a Philips I2C protocol. The I2C interface (105) can select the video input source from the video input system (101), and can select the audio source from the audio input system (104).

In some systems, a CVBS input to a CPU (112) can provide programmable on-screen display (OSD), closed-caption, feature that can output data through an input/output bus interface protocol (105) connection to the display processor (111) for overlay with the primary video channel. In some systems, the OSD features are provided by a secondary CPU, or fixed-function component, called an OSD engine (110) that passes data directly to the display processor (111). Some state-of-the-art display processors (111) integrate the OSD engine (110) in one embodiment. Some state-of-the-art display processors (111) integrate the programmable CPU (112) in one embodiment.

The display processor (111) generally includes de-interlacing technology to convert from interlaced data formatted inputs, such as provided by NTSC/PAL/SECAM analog video, to a progressive scan type format. This generally requires large amounts of video frame memory, conventionally provided by an external DRAM memory IC device (109). The display processor (111) generally includes scaling algorithms to fit video images to the target display size, algorithms such as filters to smooth edges on video images, and color space conversion algorithms. In many cases, display processors (111) include methods of overlay more than one video source, called Picture On Picture (POP) and Picture In Picture (PIP), that scale the image specifically for the purpose of overlay or side-by-side display of multiple video sources.

The display processor (111) generally outputs a high-speed low voltage differential signal interface (116) (LVDS) that multiplexes red, green, blue pixel color information to pass to the target display. Display processors integrate the digital-to-analog (D2A) circuit to create the LVDS signal interface (116) in some embodiments, while other embodiments rely on external D2A circuits. The LVDS signal interface (116) is utilized for LCD display modules (119), plasma display modules, and other types, in one embodiment. Other display module interface technologies are conceived, such as Peripheral Component Interconnect Express (PCI-Express), in other embodiment.

In the case of the LCD display module (119) of this invention, the backlighting sub-system (118) is connected to the programmable CPU (112) through an array controller interface (117), preferably implemented by means of the Philips I2C bus interface protocol in accordance with one embodiment of the present invention. Alternately, the array controller interface (117) could be a universal asynchronous transmit/receive (UART) interface protocol, a universal serial bus (USB) protocol, or a generic 8-bit slave interface in other embodiments.

The array controller interface (117) is used to transmit desired intensity information to the backlight sub-system (118). Desired intensity information is obtained through user input by means of the front panel (114) interface, a default intensity configuration that is created by a configuration procedure during the display system manufacturing process, or a color feedback management method that reads color sensor information from the display module (119) and determines a new intensity value for at least one light emitter on the backlighting sub-system (118) in accordance with embodiments of the present invention.

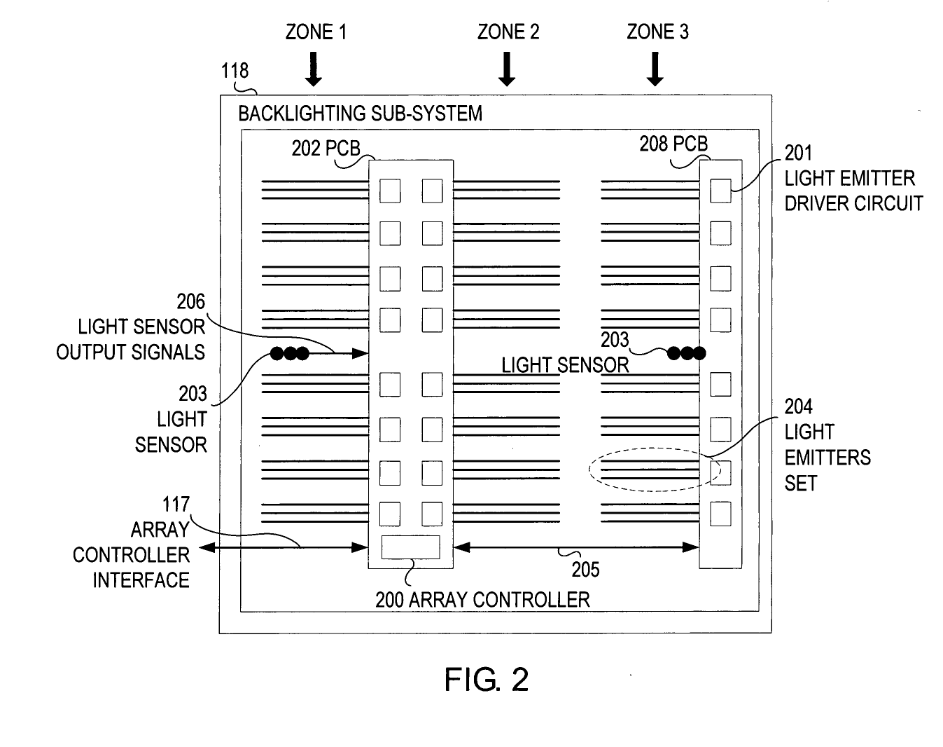

FIG. 2 illustrates more details of the LCD backlighting sub-system (118) in FIG. 1 in accordance with one embodiment of the present invention. In this embodiment, three backlighting zones are defined, each zone comprises one-third of the total light-emitters of the backlighting system. This embodiment configuration defines zone 1 as left-side vertical column, zone 2 as middle vertical column, and zone 3 as right-side vertical column. The backlighting is provided by sets of light emitters, each light emitter set (204) comprising three light emitters of primary colors; preferably a red color, green color, and blue color to optimize the limited RGB color gamut to best represent the range of human color perception. The light emitter set (204) comprise a set of strings of light emitting diode (LED) devices, where each string provides one of the three primary colors. LED devices are used in one embodiment for its low cost characteristics. Other methods of generating light, such as fluorescent lamps, is considered in other embodiments.

In the present embodiment, LCD backlighting sub-system (118) comprises two printed circuit boards (202) wherein one printed circuit board includes the array controller device (200) for making the central control, the light emitter driver circuits (201) for controlling the light emitters (204). In this embodiment, the LCD backlighting sub-system (118) further comprises two sets of light sensors (203), and each set includes a red sensor, a green sensor, and a blue sensor. The light sensors (203) outputs light sensor output signals (206) for communicating data relative to the backlighting provided by the light emitters (204).

Since the array controller (200) includes an intensity control interface to each light emitter driver circuit (201) and an input path from the light sensors (203) used to input feedback intensity data of the light emitters into the array controller, a board-to-board connection (205) is designed to pass intensity information between the two PCBs. The PCB with the array controller includes an array controller interface (117), implemented as the Philips I2C bus interface protocol in one embodiment, to communicate with a display system CPU (112).

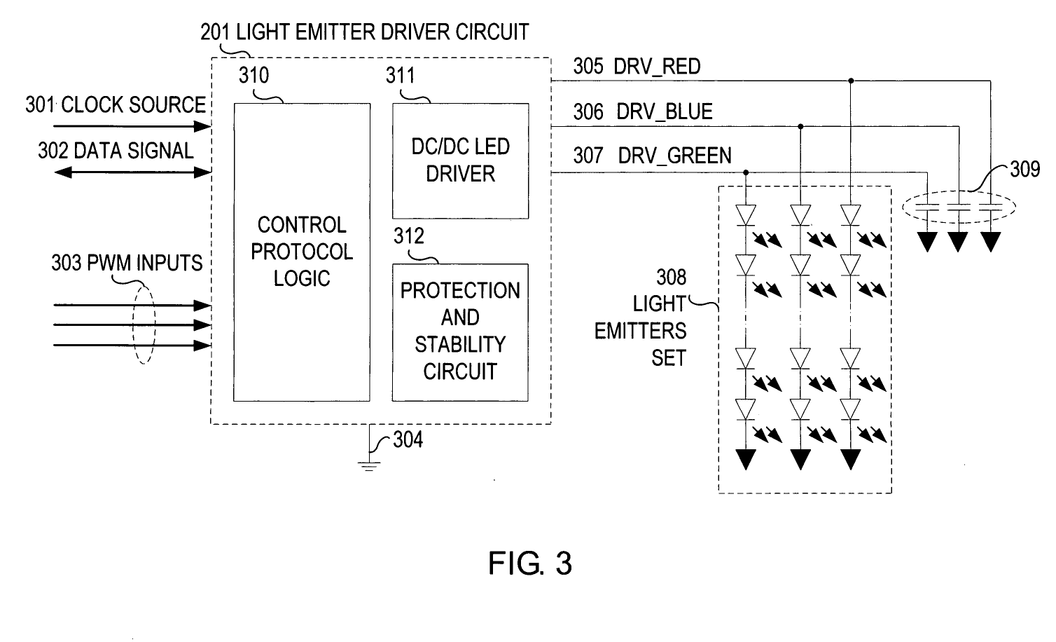

FIG. 3 illustrates a high level emitter driver circuit (201) that integrates necessary circuits to control the intensity of three separate strings of light emitters (308), preferably strings of LED devices that emit light of red, green, and blue colors. The emitter driver circuit (201) is often called an inverter circuit, and has control protocol logic (310) to input a desired light intensity, whereas light intensity is directly controlled by a voltage output, the voltage output is an analog signal with voltage value offset from the reference ground (304) plane. The emitter driver circuit (201) in FIG. 3 provides three voltage controlled light intensity outputs, DRV_RED (305), DRV_BLUE (306), and DRV_GREEN (307) to control a set of RGB LED strings (308). The output is provided by a power converter, or boost converter, circuitry (311) that performs the DC/DC LED driver function. An external capacitor (309) is connected to each color's controlled light intensity output for smoothing, in one embodiment.

As used in any embodiment herein, “circuitry” may comprise, for example, singly or in any combination, hardwired circuitry, programmable circuitry, state machine circuitry, and/or firmware that stores instructions executed by programmable circuitry.

The emitter driver circuit (201) shown in FIG. 3 supports two control protocol logic (310) methods: Philips I2C and Pulse-Width Modulation (PWM) in accordance with embodiments of the present invention.

The I2C logic has a clock source (301) for timing reference and a data signal (302) that is used to transmit the digital representation of the red, green, and blue desired intensities to registers. Philips I2C offers the advantage of acknowledgement that the transmitted data was received by means of an ACK protocol. In one embodiment, the I2C address is a fixed address, at address 7′h02 and the array controller (200) will control the I2C clock source (301) to each emitter driver circuit (201) to mask communications on the data signal (302) that are not intended for the specific emitter driver circuit (201).

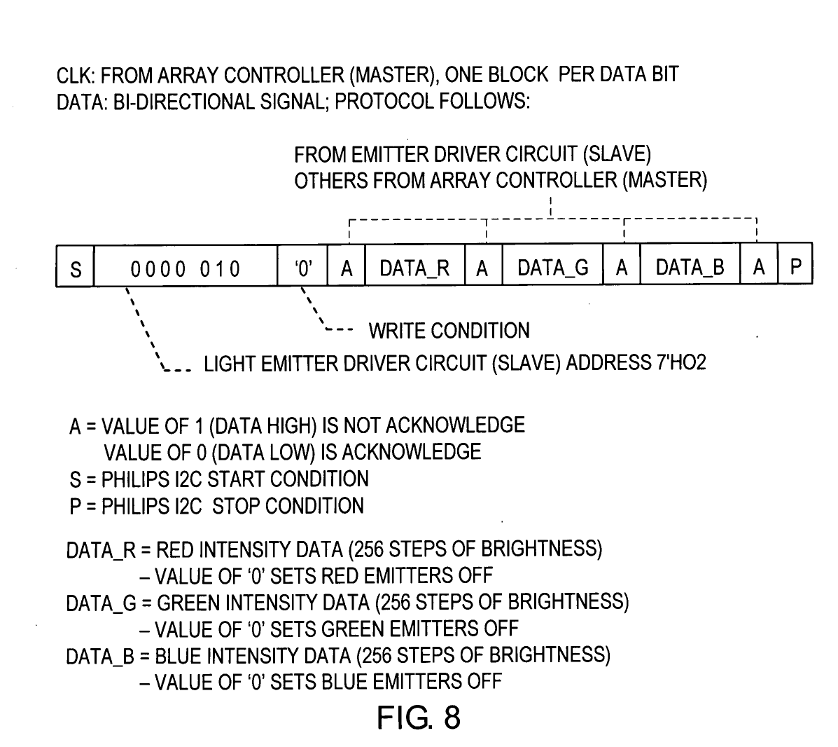

FIG. 8 illustrates the I2C protocol for communicating intensity information to the emitter driver circuit (201), conforming to the I2C Specification v 2.1 in accordance with one embodiment of the present invention. ‘A’ is from emitter driver circuit 201 (slave), wherein value of 1 (DATA high) is not acknowledge and value of 0 (DATA low) is acknowledge. Others are from array controller 200 (master), wherein ‘0000010’ means light emitter driver circuit (slave) address 7′h02, ‘S’ means Philips I2C START condition, and ‘P’ means Philips I2C STOP condition; ‘DATA_R’ means RED intensity data (256 steps of brightness), wherein value of ‘0’ sets red emitters OFF; ‘DATA_G’ means GREEN intensity data (256 steps of brightness), wherein value of ‘0’ sets green emitters OFF; and ‘DATA_B’ means BLUE intensity data (256 steps of brightness), wherein value of ‘0’ sets blue emitters OFF.

In accordance with one embodiment of the present invention, the PWM method of controlling the emitter driver circuit (201) has one PWM input for red intensity, one PWM input for green intensity, and one PWM input for blue intensity. The three PWM inputs (303) pass intensity information by the width of the PWM signal, ranging from 0% to 100%, of the period of cycle with a pre-determined frequency, a pre-determined time period. To support the PWM method, generally the emitter driver circuit (201) will contain an internal oscillator in one embodiment.

In another embodiment, emitter driver circuits (201) also include protection and stability circuits (312) to provide over-voltage protection, over-temperature protection, and a stable driver output based on feedback to a load current sensing circuit.

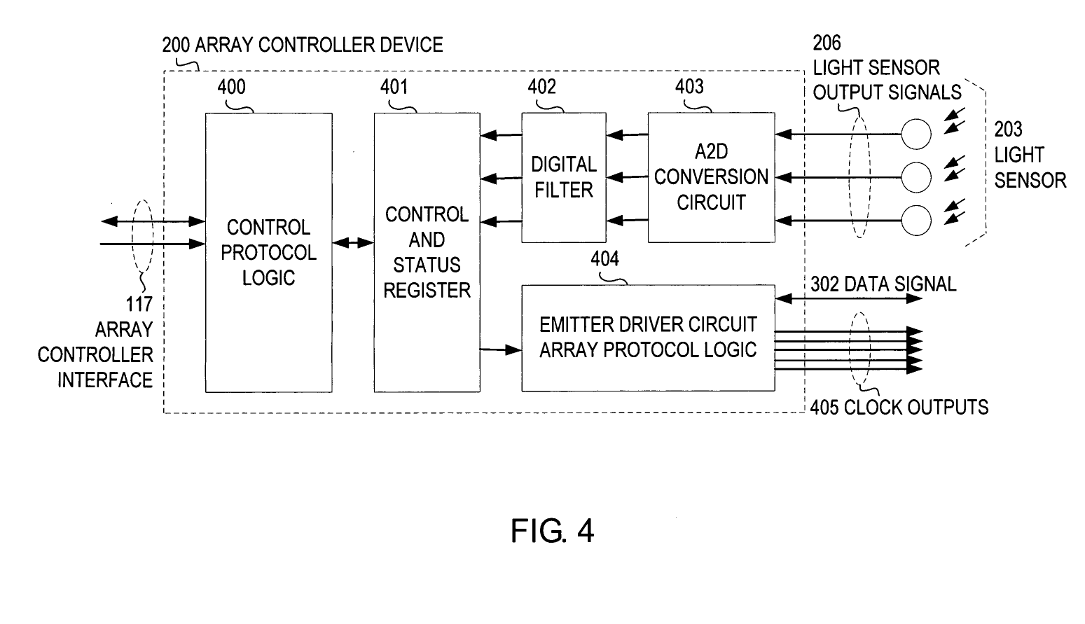

FIG. 4 illustrates a block diagram of the array controller device (200) that interfaces to a programmable CPU (112) by means of the array controller interface (117) of FIG. 2. The array controller device (200) has a control protocol logic (400) that supports the I2C protocol operating over the array controller interface (117) consisting of one clock source (301) for timing reference and a data signal (302) used to transmit and receive data in one embodiment. The array controller interface (117) is generally used to directly access a control and status register set (401).

The following Table 1 illustrates the control registers in register set (401) of FIG. 4, wherein register map in Table 1 supports “N” RGB emitter driver circuits.

TABLE 1
Control Register
WRITE - CONTROL REGISTERS

| Offset | Reg Name | Default | Description |
|---|---|---|---|
| 0 | SET_0_R | 8′h00 | Emitter 0 Red Intensity. 255 (8′hFF) is max brightness. |
| 1 | SET_0_G | 8′h00 | Emitter 0 Green Intensity. 255 (8′hFF) is max brightness. |
| 2 | SET_0_B | 8′h00 | Emitter 0 Blue Intensity. 255 (8′hFF) is max brightness. |
| 3 | SET_1_R | 8′h00 | Emitter 1 Red Intensity. 255 (8′hFF) is max brightness. |
| 4 | SET_1_G | 8′h00 | Emitter 1 Green Intensity. 255 (8′hFF) is max brightness. |
| 5 | SET_1_B | 8′h00 | Emitter 1 Blue Intensity. 255 (8′hFF) is max brightness. |
| 6 | SET_2_R | 8′h00 | Emitter 2 Red Intensity. 255 (8′hFF) is max brightness. |
| 7 | SET_2_G | 8′h00 | Emitter 2 Green Intensity. 255 (8′hFF) is max brightness. |
| 8 | SET_2_B | 8′h00 | Emitter 2 Blue Intensity. 255 (8′hFF) is max brightness. |
| 3N − 3 | SET_(N−1)_R | 8′h00 | Emitter N − 1 Red Intensity. 255 (8′hFF) is max brightness. |
| 3N − 2 | SET_(N−1)_G | 8′h00 | Emitter N − 1 Green Intensity. 255 (8′hFF) is max brightness |
| 3N − 1 | SET_(N−1)_B | 8′h00 | Emitter N − 1 Blue Intensity. 255 (8′hFF) is max brightness. |

The following Table 2 illustrates the status registers in register set (401) of FIG. 4, wherein register map in Table 2 supports “K” RGB light sensor sets.

TABLE 2
Status Register
READ - STATUS REGISTERS

| Offset | Reg Name | Default | Description |
|---|---|---|---|
| 0 | GET_0_R | 8′h00 | RGB Sensor Set 0 Red Level. 255 is max brightness.. |
| 1 | GET_0_G | 8′h00 | RGB Sensor Set 0 Green Level. 255 is max brightness. |
| 2 | GET_0_B | 8′h00 | RGB Sensor Set 0 Blue Level. 255 is max brightness. |
| 3 | GET_1_R | 8′h00 | RGB Sensor Set 1 Red Level. 255 is max brightness.. |
| 4 | GET_1_G | 8′h00 | RGB Sensor Set 1 Green Level. 255 is max brightness. |
| 5 | GET_1_B | 8′h00 | RGB Sensor Set 1 Blue Level. 255 is max brightness. |
| 6 | GET_2_R | 8′h00 | RGB Sensor Set 2 Red Level. 255 is max brightness.. |
| 7 | GET_2_G | 8′h00 | RGB Sensor Set 2 Green Level. 255 is max brightness. |
| 8 | GET_2_B | 8′h00 | RGB Sensor Set 2 Blue Level. 255 is max brightness. |
| 3K − 3 | GET_(K−1)_R | 8′h00 | RGB Sensor Set K − 1 Red Level. 255 is max brightness.. |
| 3K − 2 | GET_(K−1)_G | 8′h00 | RGB Sensor Set K − 1 Green Level. 255 is max brightness. |
| 3K − 1 | GET_(K−1)_B | 8′h00 | RGB Sensor Set K − 1 Blue Level. 255 is max brightness. |

Data written to the array controller (200) using the I2C interface (117) contains desired intensity information specific to an individual light emitter driver circuit (201). Data read from the array controller (200) using the I2C interface (117) contains color feedback data from a specific light sensor (203). Address offsets of the registers (401) are given in this figure in one embodiment.

Standard I2C methods of accessing individual registers may be performed; however, in one embodiment reads from the register set (401) are done in burst-mode whereas the entire sensor feedback register list is communicated, and writes from the register set (401) are done in burst-mode whereas the entire intensity control register list is communicated. The size of the register list depends on the array controller (200) design criteria, and the set shown here is adequate to support up to K sets of RGB light sensors (203) and N emitter driver circuits (201), each circuit (201) supporting individual red, green, and blue emitter strings as shown in FIG. 3.

The array controller (200) preferably supports at least the output signals (206) from one set of light sensors (203), detecting intensity levels of red, green, and blue colors. In one embodiment, the light sensor output signals (206) are analog signals, and the array controller contains an A2D conversion circuit (403) that converts the analog signal to a digital representation, a representation as shown in this figure that supports 256 steps of brightness; a small granularity to detect slight changes of intensity. An optional integrated digital filter (402) may filter high-frequency changes in the detected intensities in one embodiment.

The control and status registers (401) delivers desired light intensity data in one embodiment obtained through the user input by means of the front panel (114) in FIG. 1 to the emitter driver circuit array protocol logic (404); here, implemented as a Philips I2C master. The I2C master interface has one data signal (302) shared by a plurality of emitter driver circuits (201), and data transmitted/received on the data signal (302) is enabled to an individual emitter driver circuit (201) by turning on a clock source (301) to the driver circuit (201). Thus, the array controller I2C master interface contains a set of clock output sources (405), where each clock output is connected in a one-to-one configuration between the array controller (200) and it's associated array of emitter driver circuits.

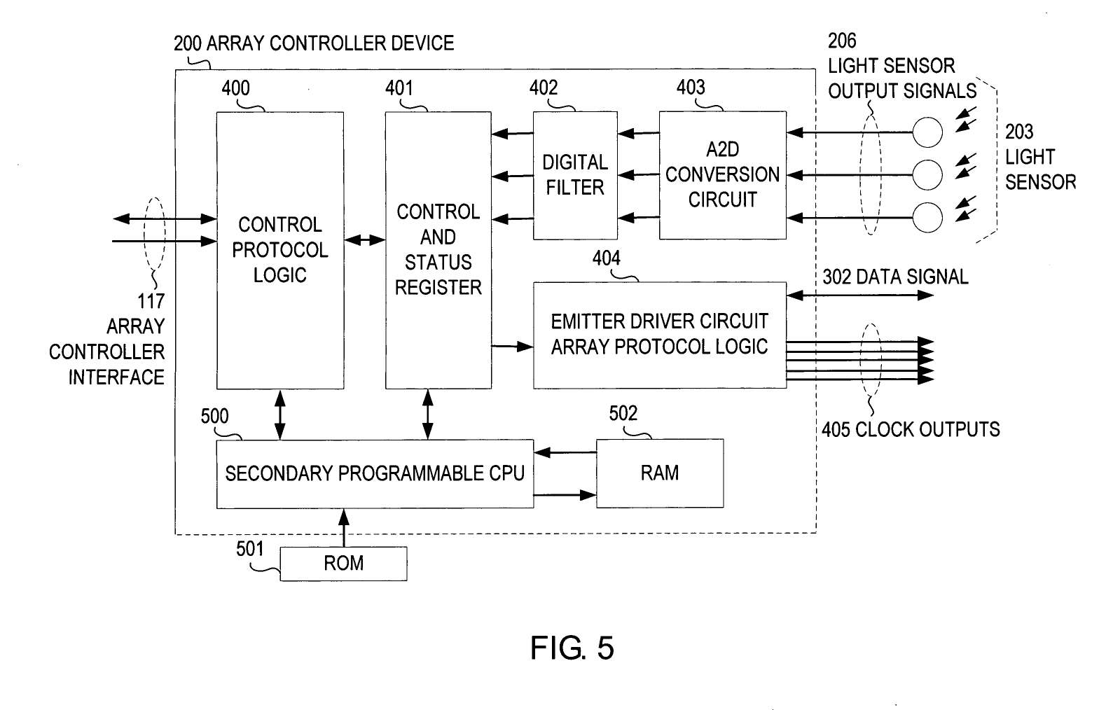

FIG. 5 illustrates an alternate embodiment of the array controller device (200) with an integrated secondary programmable CPU (500). The integrated secondary programmable CPU accesses RAM memory (502) to process instructions that are fetched from a ROM memory (501), or downloaded from the array controller signal interface (117) that is attached to a primary display system CPU (112). In this embodiment, the control and status registers (401) are directly accessed by the secondary CPU (500).

The display system architecture for a system incorporating the alternate embodiment of the array controller device (200) is consistent with that illustrated in FIG. 1. Adding the secondary CPU (500) to the array controller (200) only changes algorithmic requirements of the primary CPU (112), and the scope of communications on the array controller interface (117). In the alternate embodiment of FIG. 5, the array controller interface (117) is used to transmit desired intensity information to the backlight sub-system (118). Desired intensity information may be obtained through the user input by means of the front panel (114) interface, a default intensity configuration that may be created by a configuration procedure during the display system manufacturing process; yet, does not include obtaining desired intensity information from a color feedback management method. Instead, the secondary CPU (500) operates the methods to read color sensor information from the display module (119), by means of the array controller register set (401), and determines a new intensity value for at least one light emitter on the backlighting sub-system (118).

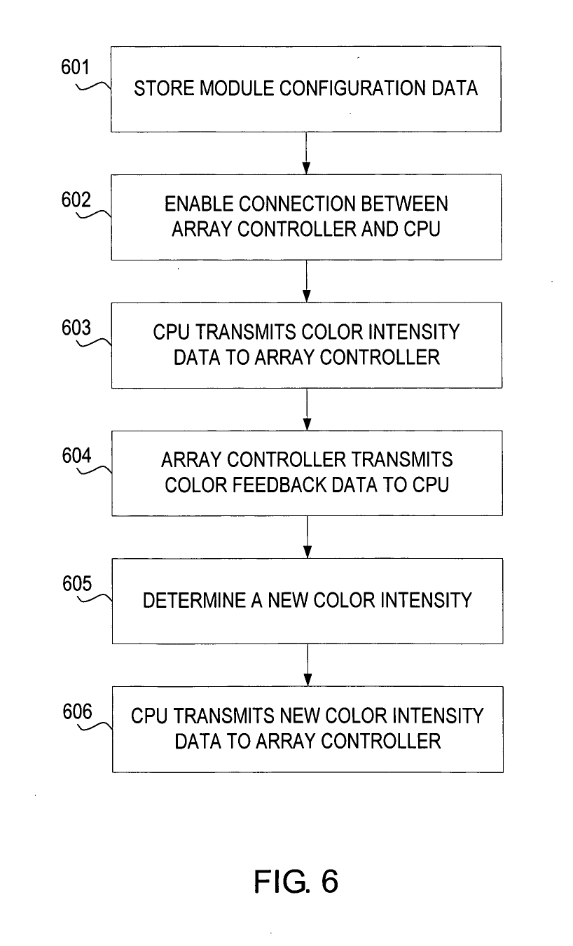

The invented display system requires one CPU to operate a color feedback management method. FIG. 6 illustrates the general method for managing color of the backlight for an LCD module described here in accordance with one embodiment of the present invention. The first operation (601) of the method in FIG. 6 is to store module configuration data to memory accessible by a programmable CPU (112, 500), whereas configuration data includes a set definition of default desired backlight color. Configuration data defines a light emitter matrix derived from the physical placement of an array of light emitters. A map of what emitter driver circuits correspond to each zone illustrated in FIG. 2.

The method of FIG. 6 includes a second operation (602) to establish a connection between a programmable CPU (112, 500) on the display system and the array controller. A Philips I2C connection is implemented for communication with an external programmable CPU (112), in one embodiment. A logical memory mapped connection is implemented for communication with an integrated CPU (500), in one embodiment.

The third operation (603) of the method involves enabling a first set of intensity data derived from module configuration data to the emitter driver circuits (201) by programming the array controller (200), through accessing the control and status registers (401).

In the fourth operation (604) the programmable CPU (112, 500) obtains the color feedback data. This is the sensor feedback data derived from an output (206) from a light sensor (203) physically placed on the LCD module (119) which is generally obtained through accessing the control and status registers (401).

The fifth operation (605) of the management system allows display system manufacturers to create sophisticated algorithms to determine a second, updated, new desired set of intensity values based on the color feedback data. The backlighting is customizable with any of the display manufactures. The manufacturers create the algorithm to meet their needs or desires.

The sixth operation (606) of the basic color management method involves enabling the new set of intensity data to the emitter driver circuits (201) by programming the array controller (200). This is accomplished through accessing the control and status registers (401).

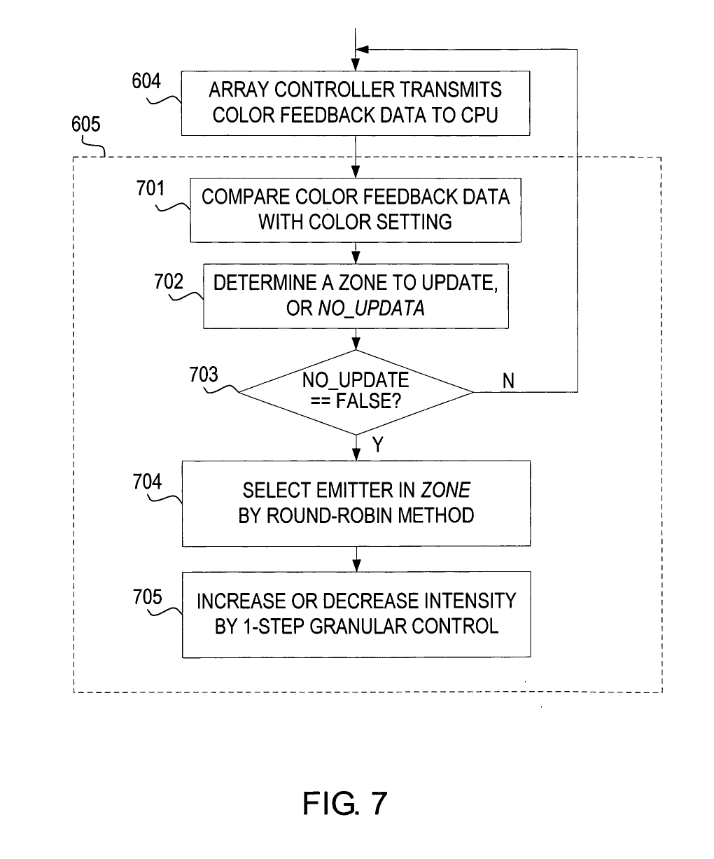

FIG. 7 illustrates a circuit selector method to calculate a second, updated, new desired color intensity data in accordance with one embodiment of the present invention.

The method of FIG. 7 takes as an input sensor feedback data obtained in operation (604) of FIG. 6. In addition, the method of FIG. 7 is a further illustration of FIG. 6. This circuit selector method includes the first operation (701) to compare sensor feedback data acquired in the general flow operation (604) in FIG. 6 and compare it to a basic desired color setting.

The second operation (702) of the circuit selector method determines a zone number, as illustrated in FIG. 2, to make an update, if necessary, to the color intensity.

At (703), if no update is required then sensor data is re-acquired at (604). On the other hand, if an update is required, the present embodiment proceeds to (704). When updating the intensity of a color in a zone, the circuit selector method uses a round-robin scheme (704) to select which emitter driver circuit to update, in one embodiment.

Updates are performed (705) on a 1-step granular basis to smooth out the adjustments; thus, to avoid perceived changes when viewing the display system such as high-frequency flicker.

The methods of FIG. 6 and FIG. 7 are operated on a polling basis in one embodiment. The methods are processed once per pre-determined time period, once per time period as system resources are available. Alternately, the methods are processed by a control signal, or interrupt, from the array controller (200), that indicates that there has been a change of state in the control and status registers (401). The optional interrupt signal may be an additional signal in the array controller signal interface (117).

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible.

What is claimed:

1. A display system comprising:
a LCD module for displaying visual information;
an array of light emitters coupled to said LCD module for providing backlighting to said LCD module;
a plurality of light emitter circuits coupled to said array of light emitters, each of which controls light intensity output for a corresponding set of light emitters in said array of light emitters; and
a central processing unit (CPU) coupled to said plurality of light emitter circuits for calculating color compensation for said set of light emitters and generating an intensity control signal for communicating desired light intensity output for each of said corresponding set of light emitters.

2. The display system of claim 1, further comprising:
an array controller coupled to said central processing unit for providing a communication interface between said central processing unit and said plurality of light emitter circuits to communicate a plurality of intensity control signals.

3. The display system of claim 1, further comprising:
at least one light sensor circuit for collecting sensor data relative to said backlighting provided by said corresponding set of light emitters, said sensor data communicated to said central processing unit for color compensation.

4. The display system of claim 1, wherein said corresponding set of light emitters comprises a plurality of red, green, and blue light emitting diodes for providing said backlighting.

5. The display system of claim 1, further comprising:
a plurality of zones, wherein each zone comprises said corresponding set of light emitters which provide said backlighting, said emitter driver circuits correspond to each zone.

6. The display system of claim 5, wherein said CPU determines a zone in said plurality zones and select an emitter driver circuit comprised in said zone to update according to said sensor data.

7. The display system of claim 1, wherein said CPU provides intensity information for the display system.

8. The display system of claim 1, further comprising:
a front panel interface coupled to said central processing unit for acquiring desired intensity information for said array of light emitters.

9. The display system of claim 1, wherein said intensity control signal is communicated to said corresponding set of light emitters using an input/output protocol substantially complying with an I2C specification.

10. The display system of claim 1, wherein said intensity control signal comprises a pulse width modulated (PWM) signal.

11. The display system of claim 1, wherein said intensity control signal is communicated to said corresponding set of light emitters using an input/output protocol substantially complying with an SMBus specification.

12. An apparatus for centralizing control of backlighting for a display, comprising:
a first logic set to enable an input/output protocol for establishing communication between a central processing unit (CPU) and a plurality of light emitter driver circuits;
a first set of registers for storing light intensity outputs for an array of light emitter driver circuits, wherein said first set of registers are programmed by means of said input/output protocol; and
a set of output terminals for communicating said light intensity outputs between said first set of registers and said plurality of light emitter driver circuits.

13. The apparatus of claim 12, wherein a register of said first set of registers controls a light emitter driver circuit of said array of light emitter driver circuits.

14. The apparatus of claim 12 wherein all elements of said array of light emitter driver circuits share a common slave address.

15. The apparatus of claim 12, further comprising:
a first set of light sense signal inputs for communicating data relative to backlighting provided by at least one light emitter of an array of light emitters, wherein said array of light emitters are controlled by said light emitter drive circuits; and
a second set of registers for storing data received by said first set of light sense signal inputs, and are used by said CPU for calculating color compensation.

16. A method for managing backlighting in a display, comprising:
storing module configuration data to a memory accessible by a programmable central processing unit (CPU);
establishing a connection between said CPU and an array controller;
enabling default intensity data from said module configuration data to light emitter driver circuits by programming said array controller through accessing registers;
obtaining intensity feedback data from color sensors;
determining a new set of intensity data based on said intensity feedback data; and
enabling said new set of intensity data to said light emitter driver circuits.

17. The method for managing backlighting in a display of claim 22, wherein said configuration data comprises a set definition of default backlight intensity.

18. The method for managing backlighting in a display of claim 22, wherein a Philips I2C provides communication with an external CPU.

19. The method for managing backlighting in a display of claim 22, wherein said determining a new set of intensity data based on said intensity feedback data comprises:
comparing said intensity feedback data to desired intensity data; and
determining a zone to make an update;

20. The method for managing backlighting in a display of claim 25, wherein said determining a zone to make an update further comprises:
if no update is required then said desired intensity data is re-acquired.

21. The method for managing backlighting in a display of claim 25, wherein said determining a zone to make an update comprises:
selecting an light emitter driver circuit to make a update.
